(19) United States
(12) Patent Application Publication
(10) Pub. No.: US 2002/0170374 A1
(43) Pub. Date: Nov. 21, 2002

(54) Energy saving gear system

(76) Inventor: David A. Stewart, Pittsburgh, PA (US)

Correspondence Address: DAVID M. O'BRIAN, 5007 HARTWELL DR., HOUSTON, TX, 77084, US

(21) Appl. No.: 10/152,368

(22) Filed: May 21, 2002

Related U.S. Application Data
(60) Provisional application No. 60/291,981, filed on May 21, 2001.

(51) Int. Cl. F16H 55/00; F16H 1/04

(52) U.S. Cl. 74/465; 74/462; 74/457; 74/422

(57) ABSTRACT

The present invention is a gear system generally having a driven gear, rotatably mounted on an axis, having teeth defined by unique geometrical profiles; a driving means contacting the teeth of the driven gear; and round pins or spheres for engaging the teeth of the driven gear rotatably mounted on the driving means, the round pins or spheres for engaging the teeth of the driven gear roll along a profile of the tooth of the driven gear; and the gear system has a variable pressure angle and a variable contact ratio.

Priority for this non-provisional patent application is claimed under 35 U.S.C. § 119, pursuant to Applicant's provisional patent application, application No. 60/291,981, filed on May 21, 2001.

### FIELD OF INVENTION

The present invention relates to an improved gear system and specifically to a gear system wherein at least one circular gear in the system includes a plurality of rotating pins or spheres instead of involute teeth. In this manner, the at least one circular gear including a plurality of rotating pins or spheres, can provide a variable pressure angle and variable contact ratio allowing force to be delivered to a driven gear as maximum torque for a correspondingly longer period of time.

### BACKGROUND OF THE INVENTION

Pressure angle is one of the primary defining characteristics for gear pairs. It is a measure of how effective the gear pairs are at transmitting torque from a driving gear to a driven gear. In a frictionless system, the driven gear with no frictional losses due to the sliding of the gear teeth on each other, receives the maximum amount of torque from the driving gear.

However, in a conventional gearing system friction is present in all gears. Gearing systems that have a larger pressure angle may be able to accept a greater load or force on the gears as compared to gearing systems with smaller pressure angles. However, larger forces applied to gearing systems, which result from a larger pressure angle, leads to more friction losses and greater gear wear. In conventional gearing systems, a large pressure angle generally indicates a correspondingly larger radial component force. Pressure angle and radial component force are proportional to each other.

The present invention relates to gearing systems having at least one circular gear, such as gear reducers, as well as rack and pinion gearing systems.

### SUMMARY OF THE INVENTION

In general, the present invention is a gearing system having:

[a] a driven gear, rotatably mounted on an axis, where the gear has unique tooth geometries compatible with the driver gear means consistent with the law of gearing;

[b] a driving gear means contacting the teeth of the driven gear means;

[c] a means for engaging the teeth of the driven gear means rotatably mounted on the driving gear means, the means for engaging the teeth of the driven means having the ability to roll along a profile of the tooth of the driven means; and the gear system including a variable pressure angle and variable contact ratio.

The means for engaging the teeth of the driven means is typically a plurality of pins that engage the teeth and roll on their profile. The contact of the pins on the teeth results in gearing geometry such that a gear pair can have a variable pressure angle. This has significant advantages on gear load and speed. The gear system of the present invention may be in a circular gear system or rack and pinion gear arrangement.

### OBJECTS OF THE INVENTION

It is the primary object of the invention to provide an improved gear system which has a variable pressure angle.

It is another object of the present invention to provide an improved gear system in which the pressure angle can be reduced so that the load on the gear system may be increased.

It is a further object of the present invention to provide an improved gear system which can operate at high velocities and heavy loads.

It is still a further object of the present invention to provide an improved gear system which may be retrofitted into an existing gear system.

It is yet another object of the present invention to provide an improved gear system in which the contact ratio between the gears may be varied.

It is also an object of the invention to provide an improved method of rolling contact between the driven teeth and the driver.

Another object of the invention is to reduce or eliminate the amount of lubrication needed for power or motion transmission between the gears.

Yet another object of the present invention is to provide an improved gear system which requires less energy to operate as compared to conventional gearing systems.

Other objects, features and advantages of the present invention will become apparent from the following detailed description taken in conjunction with the accompanying drawings.

### BRIEF DESCRIPTION OF THE DRAWINGS

The accompanying drawings which are incorporated into and constitute a part of this specification, illustrate a preferred embodiment of the invention and together with a general description of the invention given above and the detailed description of the preferred embodiment given below serve to explain the principals of the invention.

FIG. 1 is a schematic cross-sectional view of two gears of the prior art.

FIG. 2 is a schematic cross-sectional view of a rack and pinion gear system of the prior art.

FIG. 3 is a schematic cross-sectional view of a circular gear system of the present invention.

FIG. 4 is a schematic cross-sectional enlarged view of part of the gear system of FIG. 3, showing a pin and tooth relationship.

FIG. 5 is a graph of pin radius versus pressure angle relating to the present invention wherein the gears of the present invention are circular.

FIG. 6 is a schematic cross-sectional view of a rack and pinion gear system of the present invention.

FIG. 7 is a graph of pin radius versus pressure angle relating to the present invention wherein the present invention employs a rack and pinion gear system.

FIG. 8 is a schematic cross-sectional view of the split tooth and split pin embodiment of the present invention.

FIG. 9 is a schematic cross-sectional view of the stationary pin and sleeve embodiment of the present invention.

### DETAILED DESCRIPTION OF THE INVENTION

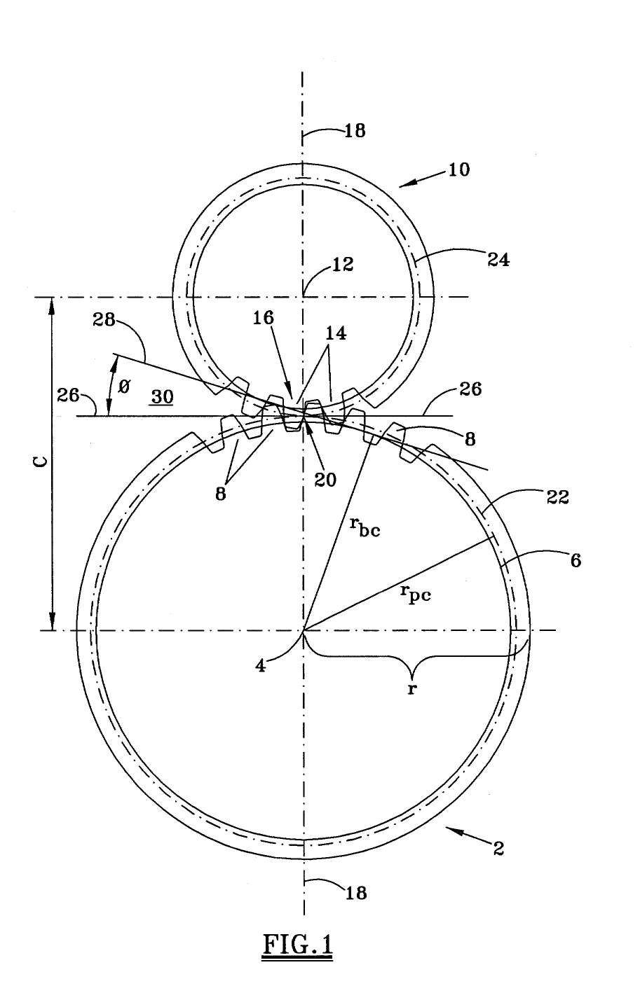

Nearly all gears used in standard gearing operations today have teeth based upon an involute profile. Referring now to FIG. 1, two prior art gears 2, 10 are illustrated. A first gear 2 is rotatable on an axis 4 and has a base circle 6 defined by radius r_{bc}. Given that base circle 6, having radius r_{bc}, the shape of the working part of each of the teeth 8 is defined as shown in FIG. 1. Teeth 8 circumscribe gear 2, but are illustrated only in one arced portion for simplicity. While other parameters of gear 2 such as undercut, the thickness of teeth 8, and the spacing of individual teeth 8 are required to completely define gear geometry, the base circle 6 alone determines the fundamental contact geometry.

In operative engagement with the first gear 2, in FIG. 1, is a second gear 10 rotatable on an axis 12. Gear 10 has a plurality of circumferentially positioned teeth 14 which contact teeth 8 of gear 2 at a mesh area 16. Teeth 14 circumscribe gear 10, but are illustrated only in one arced portion for simplicity. It is in mesh area 16 where a driving gear 10 exerts a force, typically a torque, on a driven gear 2. A driving gear 10 refers to a gear which is rotated by a power source and a driven gear 2 refers to a gear which is rotated by another gear, such as the driving gear 10. In FIG. 1 it is arbitrary which gear is the driving gear 10 and which is the driven gear 2. Thus for example only, the gear 10 will be the driving gear 10 and the gear 2 will be the driven gear 2.

The axis 4 of gear 2 and the axis 12 of gear 10 are aligned along a center line 18. The shortest distance between the axis 4 of gear 2 and the axis 12 of gear 10 is called the center distance C, denoted by the letter C in FIG. 1. In FIG. 1, the distance on the center line 18 between the axis 4 and the axis 12 is the center distance C for gear 2 and gear 10.

There exists along center line 18 a point of contact between gear 2 and gear 10 called a pitch point 20. Pitch point 20 divides the center distance C in the same proportions as the gear ratio for gear 2 and gear 10. The gear ratio for two gears is the ratio of the number of teeth 8, 14 in two engaging gears 2, 10, or the ratio of the gear spends or the ratio of the gear diameters.

Pitch point 20 defines the location of pure rolling contact between gear 2 and gear 10. It is at pitch point 20 where gear 2 and gear 10 contact in a rolling motion without slipping. For purposes of defining gear geometry, each gear, gear 2 and gear 10, has a boundary called a pitch circle which intersects pitch point 20 and circumscribes each gear. For example, gear 2 has a pitch circle 22 shown by the dashed circle in FIG. 1 defined by radius r^{pc}. Pitch circle 22 intersects pitch point 20. Likewise, gear 10 has a pitch circle 24, shown by a dashed circle, which intersects pitch point 20. Pitch point 22 and pitch circle 24 are tangent to each other.

Also intersecting pitch point 20 is a pitch line 26 which passes through the pitch point 20 and is perpendicular to the center line 18. Pitch line 26 is also tangent to pitch circle 22 and pitch circle 24.

Another line intersecting pitch point 20 is a line called the line of action 28. For involute gears the line of action 28 passes through pitch point 20 and is tangent to base circle 6 of gear 2. The line of action 28 is the line and direction along which the pressure of individual teeth 8 acts. In other words, the line of action 28 shows the direction along which maximum force or torque is transferred from gear 10, the driving gear, to gear 2, the driven gear, with a minimum of energy losses. The maximum torque transferred from gear 10, the driving gear, to gear 2, the driven gear is at the point of action 20 from teeth 14 to teeth 8.

Defined by the pitch line 26 and the line of action 28 is a pressure angle 30, also denoted in FIG. 1 by the angle Ø. Pressure angle 30 defines the angle which maximum torque may be transferred from gear 10, the driving gear, to gear 2, the driven gear. In the prior art gear system as shown in FIG. 1, the pressure angle 30 can be defined by the following equation: Ø=Sin[r_{b}÷r].

For involute spur gear systems, such as that in FIG. 1, a gear alone does not have a fixed pressure angle 30. The base circle 20 and defined operating or radius r^{pc} of pitch circle 22 determine the pressure angle 30. For any gear pair the, pressure angle 30 is determined by the base circle 6 and the center distance C for two gears. For the involute spur gear system of FIG. 1, the pressure angle 30 is constant throughout mesh area 16 and the line of action 28 always intersects center line 18 at the pitch point 20. This relationship satisfies the fundamental law of gearing and results in a constant angular velocity ratio between gear 2 and gear 10.

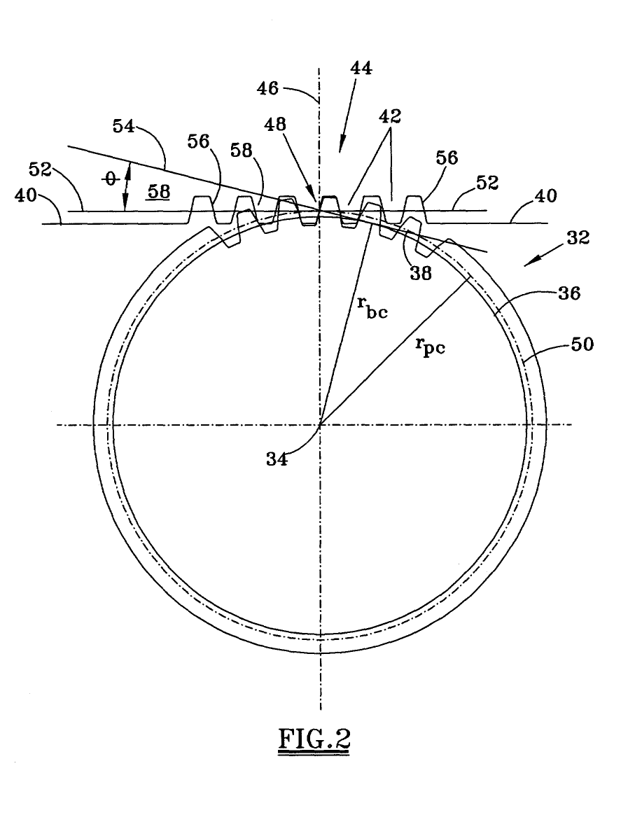

Referring now to FIG. 2, illustrating a prior art rack and pinion gear system, a pinion gear 32 rotatable on an axis 34 has a base circle 36 defined by radius r_{bc}. Given base circle 36, having radius r_{bc}, the shape of the working part of each of the teeth 38 is defined as shown in FIG. 2. Teeth 38 circumscribe pinion gear 32, but are illustrated only in one arced portion for simplicity.

In operative engagement with, and contacting the pinion gear 32, in FIG. 2, is a rack 40. Rack 40 has teeth 42 which contact teeth 38 of pinion gear 32 at a mesh area 44. It is in mesh area 44 where rack 40 exerts a force on pinion gear 32.

In FIG. 2, there exists along a vertical line 46 a point of contact between pinion gear 32 and rack 40 called a pitch point 48. Pitch point 48 defines the location of pure rolling contact between pinion gear 32 and rack 40. It is at pitch point 48 where pinion gear 32 and rack 40 contact in a rolling motion without slipping. For purposes of defining gear geometry, pinion gear 32 has a boundary called a pitch circle 50 which intersects pitch point 48 and circumscribes pinion gear 32. For example, pinion gear 32 includes pitch circle 50 shown in FIG. 2 as the dashed circle and defined by radius r_{pc}. Pitch circle 50 intersects pitch point 48.

Also intersecting pitch point 48 is a pitch line 52 which passes through the pitch point 48 and is perpendicular to the vertical line 46. Pitch line 52 is also tangent to pitch circle 50.

Another line intersecting pitch point 48 is a line called the line of action 54. In a rack and pinion gear system, the line of action 54 is normal to the profile 56 of the individual teeth 42 of rack 40. Again, the line of action 54 is the line and direction along which the pressure of individual teeth 42 acts.

Defined by the pitch line 52 and the line of action 54 is a pressure angle 58, also depicted in FIG. 2 by the angle Ø. Pressure angle 58 defines the angle at which maximum torque may be transferred from rack 40 to pinion gear 32. In the prior art rack 40 and pinion gear 32 system shown in FIG. 2, the pressure angle 58 can also be defined by Ø=Sin[r_{b}÷r].

For the rack and pinion gear system of FIG. 2, the pressure angle 58 is determined by the angle of individual teeth 42 because the line of action 54 is normal to the profile 56 of individual teeth 42. Moving the rack 40 further from the axis 34 of pinion gear 32 has no effect on pressure angle 58.

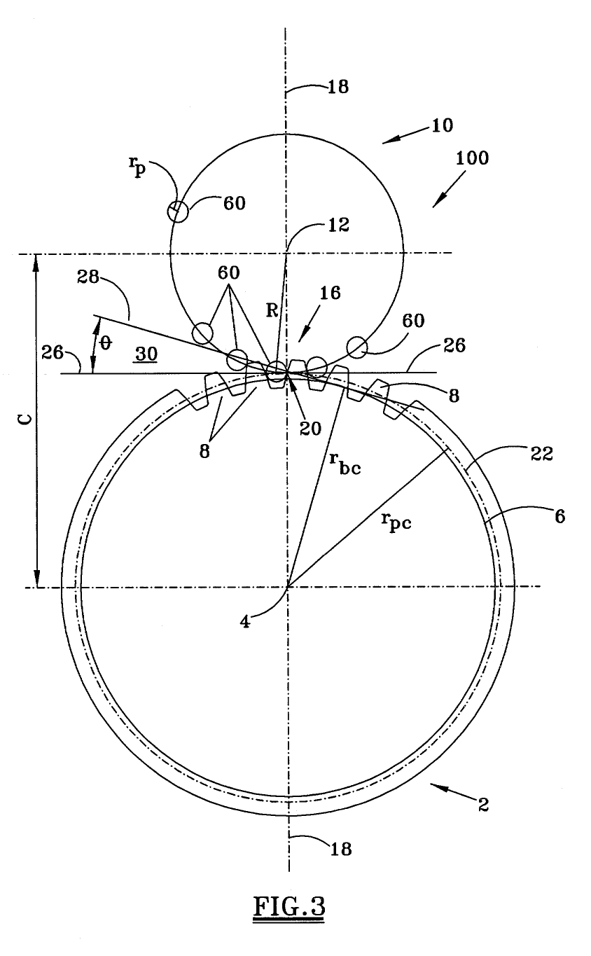

The gear system of the present invention 100, as illustrated in the embodiment in FIG. 3, is constructed similar to a spur gear system, except that substituted in place of the involute teeth of one of the gears, there are rotating pins 60 which may be cylindrical or spherical in shape. The rotating pins 60 are preferably made of a material that has a strong wear resistance, for example, i.e. metal. The rotating pins 60 and gear teeth 8 in which they engage may preferably be coated with a friction reducing material. The gearing system of the present invention 100, having rotating pins 60 that interact with gear teeth 8, has advantages not found in common involute gearing. Instead advantages are created in the present invention that never before have been realized.

In FIG.3, the reference numbers that are the same as the reference numbers of FIG. 1 correspond to like parts. Gear 10 has a plurality of pins 60 around the entire gear, instead of involute teeth. Pins 60 are a means for engaging teeth 8 of gear 2. Again it is arbitrary which gear is the driving gear and which is the driven gear, but for the embodiment shown in FIG. 3, gear 10 will be the driving gear and gear 2 will be the driven gear.

In the gear system of the present invention 100, the teeth 8 and the pins 60 of gear 10 produce a variable pressure angle 30. The reason for the variable pressure angle 30 is explained below.

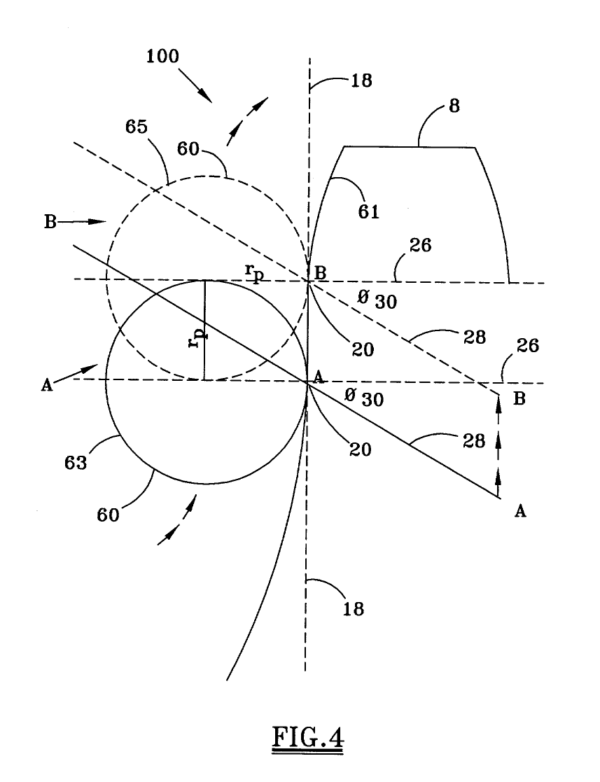

In the gear system of the present invention 100, the pressure angle 30 is variable. This is because as each of the pins 60 rotate on the individual teeth 8 in the mesh area 16 resulting in constant direct physical contact between pins 60 and each of the teeth 8, as illustrated in FIG. 4. FIG. 4 is an enlarged view of one of pins 60, having a radius rₚ, in contact with the profile 61 of one of teeth 8. The solid circle 63 represents a single pin 60 in a first position A and the dashed circle 65 indicates the single pin 60 in a second position B.

FIG. 4 illustrates that the point of contact 20 moves along the profile 61 of each individual teeth 8, from position A to position B, as each of the individual pins 60 rotates and rolls up the profile 61. As the contact point 20 moves along the edge of profile 61 from position A to position B, each of the pins 60 is in substantially perfect rolling contact with one of the teeth 8. It is along this profile 61 that maximum torque can be delivered from the driving gear to the driven gear with a minimum of loss.

The moving contact point 20 between the pin 60 and tooth 8 results in a line of action 28 which rotates and must intersect the pitch point 20 at all times to satisfy the fundamental law of gearing. The line of action 28 moves from position A to position B and changes the pressure angle 30 defined between the line of action 28 and the pitch line 26. Therefore, the pressure angle 30 is not fixed during the time of contact of each of individual pins 60 on each of individual teeth 8.

The moving contact point 20 allows force to be delivered along the line of action 28 for a longer period of time, allowing force to be delivered as maximum torque for a correspondingly longer period of time. This therefore allows greater torque to be delivered to gear 2 for a longer period of time. It is in this way that pressure angle 30 is variable.

As illustrated in FIG. 3, pressure angle 30 is found by solving the following equation: C=[r_{b}÷cos Ø]+rₚ Sin Ø, where C is the center distance between gear 2 and gear 10. r_{b} is the base circle radius and rₚ is the radius of the pin 60. For the present invention 100 illustrated in FIG. 3, the pressure angle 30 will vary about 2 to 7 degrees.

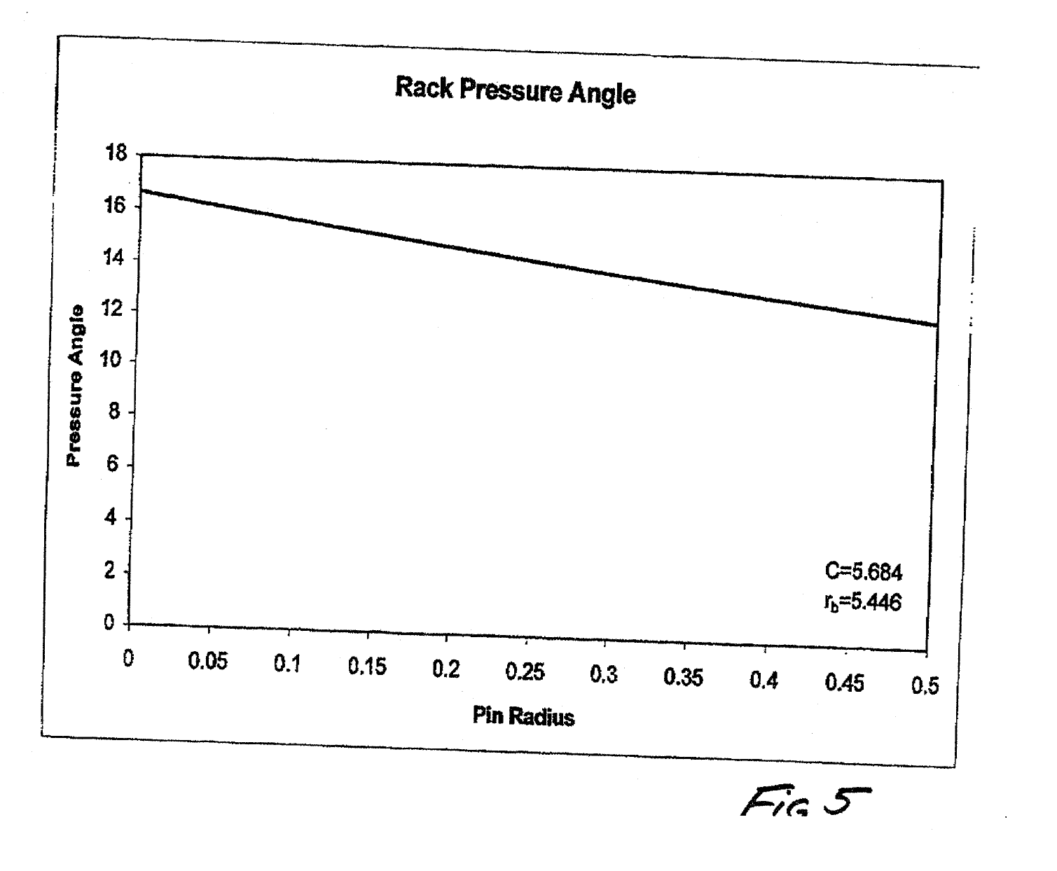

As an example of the variation in pressure angle 30 in the system shown in FIG. 3, FIG. 5 shows a graph of pin radius versus pressure angle at a center distance of C=5.684. The radius of the base circle 6 of gear 2 is equal to 5.446. As shown in FIG. 5, the pressure angle 30 decreases as pin radius of each of individual pins 60 on gear 10 increases.

The reason for the decrease in pressure angle 30 with an increase in the radius of each of individual pins 60 is that the area of contact between a larger pin, and an involute tooth is larger and therefore the pitch point does not change or move as significantly with the moving of the larger pin. In other words, the angle of separation between the larger pin on the involute tooth is smaller and therefore the pitch point does not move as much with a larger pin as with a smaller pin. If the pitch point does not change as much then the line of action will not change as much and the pressure angle will be smaller.

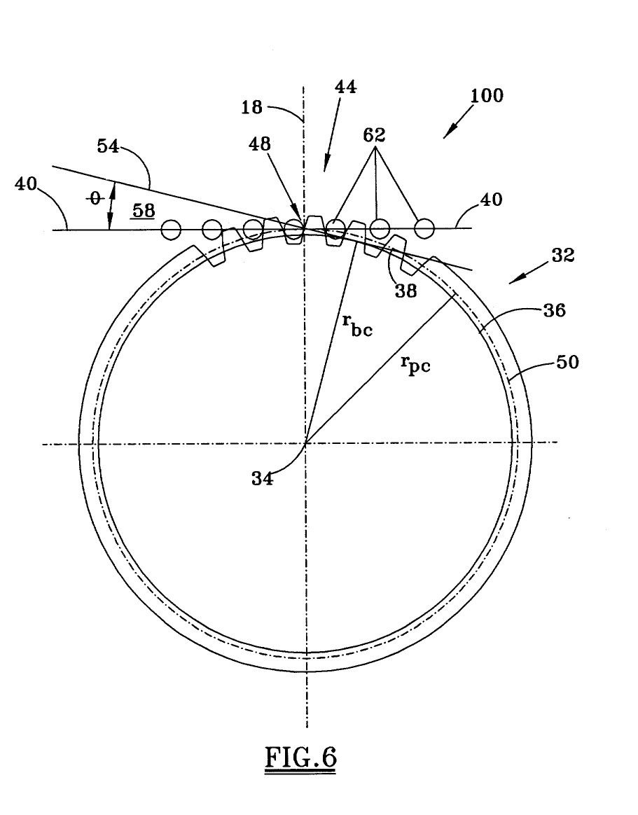

The gear system of the present invention 100, as illustrated in another embodiment in FIG. 6, is constructed similar to a rack 40 and pinion gear 32 system, except in place of the involute teeth of the rack are rotating pins 62 which may be cylindrical or spherical in shape. The rotating pins 62 are preferably made of a material that has a strong wear resistance, like metal. The gearing system of this embodiment of the present invention 100 with rotating pins 62 that interact with involute gear teeth 38 does not follow the conventional and fundamental laws of gearing.

In FIG. 6, the reference numbers that are the same as the reference numbers in FIG. 2 correspond to like parts. Rack 40 has a plurality of pins 62. Pins 62 are a means for engaging teeth 38 of pinion gear 32.

In the gear system of FIG. 6, the involute teeth 32 of pinion gear 38 and the pins 62 of rack 40 produce neither a constant angular velocity or a constant pressure angle 58 for the same reasons as explained for the embodiment of FIG. 3 and shown in FIG. 4. The pressure angle can be found by solving the following non-linear equation, where R²=rₚ²+[C−(r_{b}÷cos Ø)]−{2rₚ[C−(r_{b}÷cos Ø)]Sin Ø} and where C is the center distance, r_{b} is the base circle radius and rₚ is the radius of the pin. For the present invention illustrated in FIG. 6, the pressure angle 58 will vary about 2 to 7 degrees.

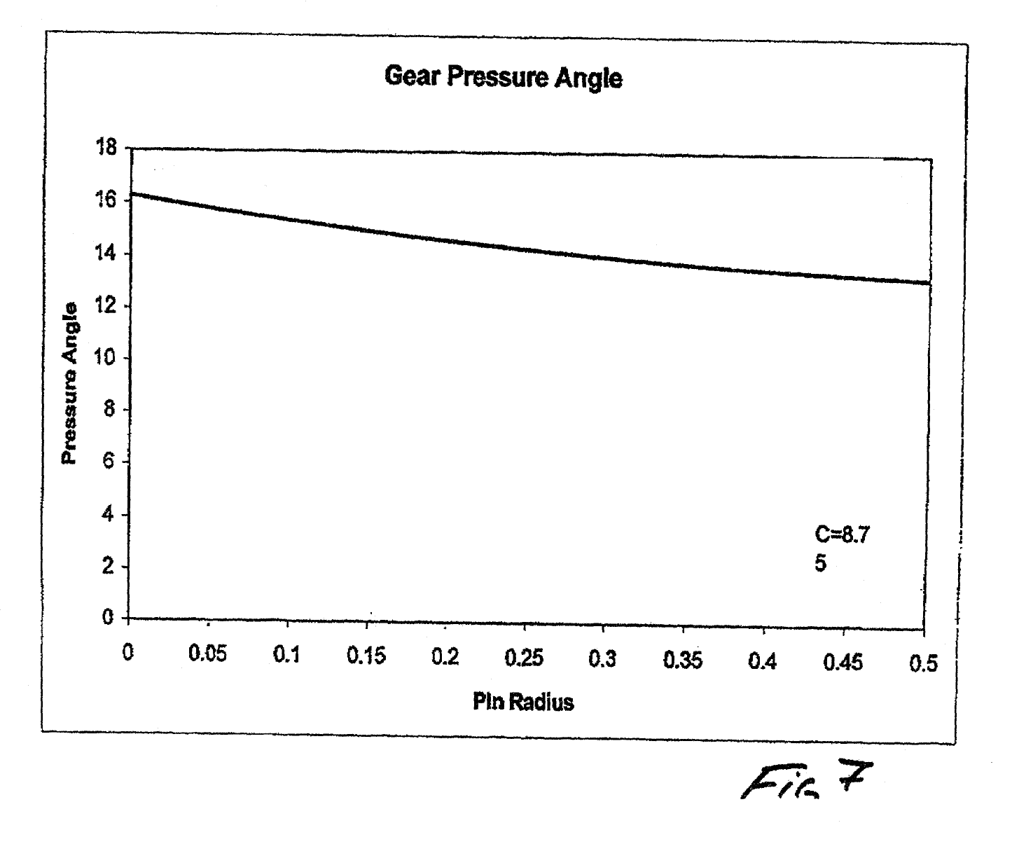

As an example of the variation in pressure angle 58 in the system shown in FIG. 6, FIG. 7 shows a graph of pin radius versus pressure angle at a center distance of C=8.7. The radius of base circle 36 of gear 32 is equal to 5. As shown in FIG. 7, pressure angle 58 decreases as pin radius of each of individual pins 62 on gear 32 increases.

For the present invention in FIGS. 3-7 the pressure angle can be minimized if the radius of the pin is maximized. For the gear system of the present invention, in which the radius of the means for engaging the involute teeth of the driven means is defined at a maximum as effectively less than the distance between midpoints of two involute teeth and for a constant distance between the driven means and the driving means, if the radius of the means for engaging the involute teeth of the driven means is maximized then the pressure angle of the gear system is minimized. Minimizing the pressure angle decreases the radial forces on the gear. However the advantage of the present invention is that even though the pressure angle is minimized, maximum torque can be delivered for the duration of the contact time between each individual gear teeth and each of the plurality of pins.

In both the embodiments shown in FIG. 3 and 6, the contact ratio varies as a function of pin diameter. The contact ratio is a measure of the number of gear teeth in full contact with the pins. A higher contact ratio provides increased load and torque capacity. In the present invention contact ratio varies from about 1 to 2.5 for a pin diameter of 20 to 90 mm.

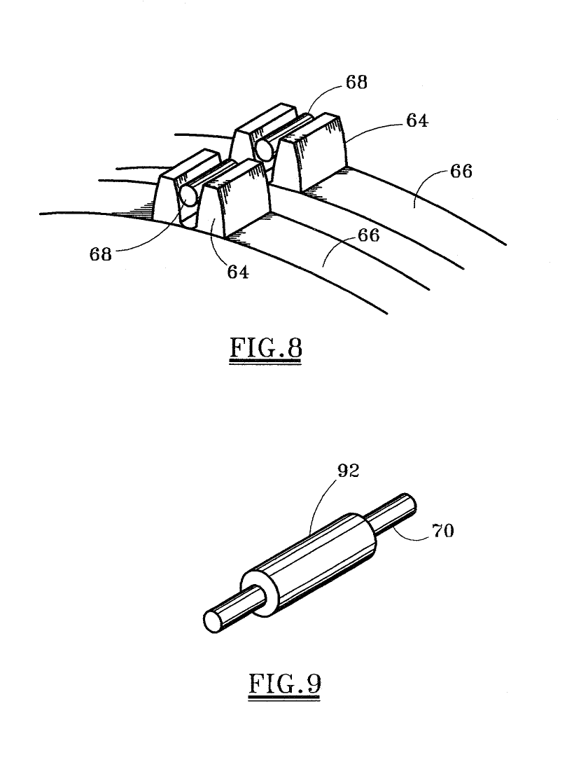

Another embodiment of the present invention is a split tooth and split pin arrangement, as illustrated in FIG. 8. FIG. 8 shows a split involute tooth 64 on a gear 66 engaging with a split involute pin 68. Split involute pin 68 could be mounted on either a gear or a rack of a rack and pinion gear system. The difference between the split tooth and split pin arrangement is that the contact areas between the pin and gear tooth are separated by a gap in which there is no contact between the pin and the tooth.

A further embodiment is the sleeve arrangement illustrated in FIG. 9. This embodiment uses a plurality of stationary pins 70 on which are mounted sleeves 72 which can rotate around pins 70. This embodiment has several advantages, namely, ease of assembly and ease of retrofitting. Further the sleeve 72 replaces the need to make the pins 70 rotatable on both ends. The pin diameter can also be reduced.

While there has been illustrated and described several embodiments of the present invention, it will be apparent that various changes and modifications thereof will occur to those skilled in the art. It is intended in the appended claims to cover all such changes and modifications that fall within the true spirit and scope of the present invention.

What is claimed is:

1. An energy saving gear system comprising:
a driven means, rotatably mounted on an axis, having a plurality of involute teeth mounted circumferentially thereto;
a driving means in operative engagement with the involute teeth of said driven means; and
a means for engaging the involute teeth of the driven means in conjunction with the driving means, said means for engaging the involute teeth of the driven means remaining in substantial rolling contact to a profile of a plurality of involute teeth of the driven means; and
wherein the means for engaging the involute teeth of the driven means provides a variable pressure angle and a variable contact ratio of the gear system.

2. The gear system of claim 1, wherein said driven means includes a driven gear having a plurality of involute teeth circumferentially mounted thereto and said driving means includes a driving gear having a plurality of pins circumferentially mounted thereto.

3. The gear system of claim 2, wherein the means for engaging the involute teeth of the driven gear includes the plurality of pins circumferentially mounted to the driving gear, wherein the pins have a circular cross-section.

4. The gear system of claim 3, wherein the variable pressure angle is in the range of 2 to 7 degrees.

5. The gear system of claim 4, wherein the variable pressure angle decreases as a factor of the uniform radius of the plurality of pins on the driving gear increases.

6. The gear system of claim 5, wherein the contact ratio varies as a function of the uniform differential in the diameter of the plurality of pins on the driving gear.

7. The gear system of claim 6, wherein the contact ratio is a measure of the number of involute gear teeth of the driven gear in full contact with the plurality of pins of the driving gear.

8. The gear system of claim 7, wherein a high contact ratio provides for increased load and torque capacity to the gear system.

9. The gear system of claim 7, wherein the contact ratio is in the range of 1 to 2.5.

10. The gear system of claim 1, wherein the driven means and the driving means do not require an external layer of a friction reducing material.

11. The gear system of claim 1, in which the radius of the means for engaging the teeth of the driven means is defined at a maximum as effectively less than the distance between midpoints of the two teeth for a constant distance between the driven means and the driving means, if the radius of the means for engaging the teeth of the driven means is maximized then the pressure angle of the gear system is minimized.

12. The gear system of claim 4, wherein the variable pressure angle between two circular gears is calculated as follows: C=[r_{b}÷cos Ø]+rₚ Sin Ø, where C is the center distance between gear 2 and gear 10, r_{b} is the base circle radius and rₚ is the radius of the pin 60.

13. An energy saving gear system comprising:
a driven gear, rotatably mounted on an axis, having a plurality of involute teeth circumferentially mounted there to;
a driving gear in operative engagement with the involute teeth of said driven gear; and
a plurality of round pins circumferentially and rotatably mounted to said driving gear for engaging the involute teeth of the driven gear, said round pins being designed to engage and make substantial rolling contact with a profile of each of the plurality of involute teeth of the driven gear; and
wherein the gear system has a variable pressure angle and a variable contact ratio.

14. A rack and pinion energy saving gear system comprising;
a pinion gear, rotatably mounted on an axis, having a plurality of involute teeth;
a rack contacting the involute teeth of the pinion gear; and
pins for engaging the involute teeth of the pinion gear rotatably mounted on the rack; wherein the rack and pinion gear system has a variable pressure angle and variable contact ratio.

15. The rack and pinion gear system of claim 14, wherein the pins for engaging the pinion gear have a circular cross-section.

16. The rack and pinion gear system of claim 15, wherein the variable pressure angle between the pinion gear and the rack is calculated as follows: R²=rₚ²+[C−(r_{b}÷cos Ø]−{2rₚ[C −(r_{b}÷cos Ø)]Sin Ø} where C is the center distance, r_{b} is the base circle radius and rₚ is the radius of the pin 60.

17. The rack and pinion gear system of claim 16, wherein the variable pressure angle is in the range of 2 to 7 degrees.

18. The rack and pinion gear system of claim 14, wherein the contact ratio varies as a function of the uniform differential in the diameter of the plurality of pins on the rack.

19. The rack and pinion gear system of claim 18, wherein the contact ratio is a measure of the number of involute gear teeth of the pinion gear in full contact with the plurality of pins of the rack.

20. The rack and pinion gear system of claim 19, wherein a high contact ratio provides for increased load and torque capacity to the gear system.
